(19) United States
(12) Patent Application Publication
(10) Pub. No.: US 2024/0092387 A1
(43) Pub. Date: Mar. 21, 2024

(54) Method and Apparatus for Indication of Motion

(71) Applicant: APPLE INC., Cupertino, CA (US)

(72) Inventors: Max Fahrenkopf, Palo Alto, CA (US); Tom Hsu, Santa Clara, CA (US); Ying Yi Lim, Santa Clara, CA (US)

(21) Appl. No.: 18/231,879

(22) Filed: Aug. 9, 2023

Related U.S. Application Data
(60) Provisional application No. 63/407,217, filed on Sep. 16, 2022.

(51) Int. Cl. B60W 60/00; G01C 21/34

(52) U.S. Cl. CPC B60W 60/0013; B60W 60/0021; G01C 21/3461; G01C 21/3484; B60W 2540/00; B60W 2554/00

(57) ABSTRACT

A method includes determining a first motion plan and a second motion plan based on inputs and determining a preference for the first motion plan relative to the second motion plan. The method also includes identifying one of the inputs as a sensitive input that causes the preference for the first motion plan over the second motion plan, and presenting, using a display, information that describes the first motion plan. The information includes an explanation indicating the sensitive input as a reason why the first motion plan is preferred over the second motion plan. The method also includes communicating and initiating the preferred motion plan.

### CROSS-REFERENCE TO RELATED APPLICATIONS

This application claims the benefit of, and priority to, U.S. Provisional Application No. 63/407,217, filed on Sep. 16, 2022, the contents of which are hereby incorporated by reference in their entirety herein for all purposes.

### FIELD

The present disclosure relates generally to the field of intent indication for computing systems.

### BACKGROUND

Some automated systems are able to make decisions and act according to those decisions, such as by moving within an environment. Users may gain insight into the automated system when future actions of the system are communicated.

### SUMMARY

A first aspect of the disclosure is a method that includes determining a first motion plan and a second motion plan for a mobile electronic device based on inputs. The method also includes determining a preference for the first motion plan relative to the second motion plan. The method also includes identifying one of the inputs as a sensitive input that causes the preference for the first motion plan over the second motion plan. The method also includes presenting, using a display, information that describes the first motion plan, wherein the information includes an explanation indicating the sensitive input as a reason why the first motion plan is preferred over the second motion plan. The method also includes controlling the mobile electronic device using one of the first motion plan or the second motion plan.

In some implementations of the method according to the first aspect of the disclosure, the explanation includes text determined based on the sensitive input. In some implementations, of the method according to the first aspect of the disclosure, the explanation includes an icon that represents the sensitive input. In some implementations of the method according to the first aspect of the disclosure, the indication that explains why the first motion plan is preferred over the second motion plan includes text that is determined based on the sensitive input. In some implementations of the method according to the first aspect of the disclosure, the indication that explains why the first motion plan is preferred over the second motion plan includes an icon that represents the sensitive input.

In some implementations of the method according to the first aspect of the disclosure, the sensitive input relates to occupant comfort. In some implementations of the method according to the first aspect of the disclosure, the sensitive input relates to travel path planning. In some implementations of the method according to the first aspect of the disclosure, the sensitive input relates to travel time.

In some implementations of the method according to the first aspect of the disclosure, the sensitivity analysis includes modifying at least some of the inputs, and modification of the sensitive input causes the first score for the first motion plan to decrease so that it is lower than the second score for the second motion plan. In some implementations of the method according to the first aspect of the disclosure, the first motion plan comprises a first intended travel path around an obstacle, and the second motion plan comprises a second intended travel path different from the first travel path.

In some implementations of the method according to the first aspect of the disclosure, presenting the information that describes the first motion plan includes display of a first motion plan representation of the first motion plan and a second motion plan representation of the second motion plan. In some implementations of the method according to the first aspect of the disclosure, the first motion plan representation of the first motion plan and the second motion plan representation of the second motion plan are displayed with differing visual indications such as at least one of differing colors or differing opacities. In some implementations, the inputs are obtained by sensors of the mobile electronic device. The features noted above may be combined with each other.

A second aspect of the disclosure is a non-transitory computer-readable storage device including program instructions executable by one or more processors. When executed, the program instructions cause the one or more processors to perform operations. The operations include determining a first motion plan and a second motion plan for a mobile electronic device based on inputs. The operations also include determining a preference for the first motion plan relative to the second motion plan. The operations further include identifying one of the inputs as a sensitive input that causes the preference for the first motion plan over the second motion plan. The operations also include presenting, using a display, information that describes the first motion plan, wherein the information includes an explanation indicating the sensitive input as a reason why the first motion plan is preferred over the second motion plan. The operations also include controlling the mobile electronic device using one of the first motion plan or the second motion plan.

A third aspect of the disclosure is an apparatus that includes a memory and one or more processors that are configured to execute instructions that are stored in the memory. The instructions, when executed, cause the one or more processors to determine a first motion plan and a second motion plan for a mobile electronic device based on inputs. The instructions, when executed, also cause the one or more processors to determine a preference for the first motion plan relative to the second motion plan, identify one of the inputs as a sensitive input that causes the preference for the first motion plan over the second motion plan, present, using a display, information that describes the first motion plan, wherein the information includes an explanation indicating the sensitive input as a reason why the first motion plan is preferred over the second motion plan, and control the mobile electronic device using one of the first motion plan or the second motion plan.

A fourth aspect of the disclosure is a method that includes, at a mobile electronic device located in an environment, determining a motion plan for the mobile electronic device based on inputs, wherein the motion plan includes a motion maneuver comprising a planned path around an object, analyzing the inputs to identify a feature of the environment that caused the motion maneuver to be included in the motion plan, presenting, using a display, information that describes the motion maneuver and identifies the feature of the environment, and controlling the mobile electronic device using the motion plan.

In some implementations of the method according to the fourth aspect of the disclosure, analyzing the inputs to identify the feature of the environment that caused the motion maneuver to be included in the motion plan comprises identifying the feature of the environment by performing a sensitivity analysis. In some implementations of the method according to the fourth aspect of the disclosure, the information that describes the motion maneuver and identifies the feature of the environment comprises outputting text that identifies the feature of the environment. In some implementations of the method according to the fourth aspect of the disclosure, presenting, to the user, the information that describes the motion maneuver and identifies the feature of the environment comprises displaying an icon that represents the feature of the environment. In some implementations of the method according to the fourth aspect of the disclosure, presenting, to the user, the information that describes the motion maneuver and identifies the feature of the environment comprises displaying a motion plan representation that represents the motion maneuver. In some implementations of the method according to the fourth aspect of the disclosure, the feature of the environment is a dynamic object. In some implementations of the method according to the fourth aspect of the disclosure, the feature of the environment is a static object. In some implementations, the inputs are obtained by sensors of the mobile electronic device. The features noted above may be combined with each other.

A fifth aspect of the disclosure is a non-transitory computer-readable storage device including program instructions executable by one or more processors that, when executed, cause the one or more processors to perform operations. The operations include, at a mobile electronic device located in an environment, determining a motion plan for the mobile electronic device based on inputs, wherein the motion plan includes a motion maneuver comprising a planned path around an object, analyzing the inputs to identify a feature of the environment that caused the motion maneuver to be included in the motion plan, presenting, using a display, information that describes the motion maneuver and identifies the feature of the environment, and controlling the mobile electronic device using the motion plan.

A sixth aspect of the disclosure is an apparatus that includes a memory, and one or more processors that are configured to execute instructions that are stored in the memory. The instructions, when executed, cause the one or more processors to, at a mobile electronic device located in an environment, determine a motion plan for the mobile electronic device based on inputs, wherein the motion plan includes a motion maneuver comprising a planned path around an object, analyze the inputs to identify a feature of the environment that caused the motion maneuver to be included in the motion plan, present, using a display, information that describes the motion maneuver and identifies the feature of the environment, and control the mobile electronic device using the motion plan.

A seventh aspect of the disclosure is a method that includes determining a motion plan for a mobile electronic device, and displaying, using a display, an environment representation, wherein the environment representation is a graphical representation of an environment around the mobile electronic device. The method also includes displaying, to the user, a motion plan representation overlaid on the environment representation, the motion plan representation indicating an area of the environment in which the mobile electronic device may travel within a time horizon, the motion plan representation extending from a first end corresponding to a current location of the mobile electronic device to a second end corresponding to an expected future location of the mobile electronic device at an end of the time horizon, wherein the motion plan representation is updated continuously to reflect changes to the current location of the mobile electronic device and changes to the motion plan. The method also includes controlling the mobile electronic device using the motion plan.

In some implementations of the method according to the seventh aspect of the disclosure, the environment representation includes a map. In some implementations of the method according to the seventh aspect of the disclosure, the end of the time horizon is determined by adding a fixed duration time interval to a current time. In some implementations of the method according to the seventh aspect of the disclosure, a length of the motion plan representation between the first end of the motion plan representation and the second end of the motion plan representation represents an expected travel distance of the mobile electronic device during the time horizon, and the length of the motion plan representation is updated continuously to reflect changes to the current location of the mobile electronic device and changes to the motion plan. In some implementations of the method according to the seventh aspect of the disclosure, a color of at least a portion of the motion plan representation represents an acceleration of the mobile electronic device during the time horizon. In some implementations of the method according to the seventh aspect of the disclosure, the motion plan representation is a first motion plan representation and the motion plan is a first motion plan, and the method further includes determining a second motion plan, and displaying, to the user, a second motion plan representation of the second motion plan overlaid on the environment representation. In some implementations of the method according to the seventh aspect of the disclosure, the first motion plan representation of the first motion plan and the second motion plan representation of the second motion plan are displayed with at least one of differing colors or differing opacities. The features noted above may be combined with each other.

An eighth aspect of the disclosure is a non-transitory computer-readable storage device including program instructions executable by one or more processors that, when executed, cause the one or more processors to perform operations. The operations include determining a motion plan for a mobile electronic device, and displaying, using a display, an environment representation, wherein the environment representation is a graphical representation of an environment around the mobile electronic device. The operations also include displaying, to the user, a motion plan representation overlaid on the environment representation, the motion plan representation indicating an area of the environment in which the mobile electronic device may travel within a time horizon, the motion plan representation extending from a first end corresponding to a current location of the mobile electronic device to a second end corresponding to an expected future location of the mobile electronic device at an end of the time horizon, wherein the motion plan representation is updated continuously to reflect changes to the current location of the mobile electronic device and changes to the motion plan. The operations also include controlling the mobile electronic device using the motion plan.

A ninth aspect of the disclosure is an apparatus that includes a memory, and one or more processors that are configured to execute instructions that are stored in the memory. The instructions, when executed, cause the one or more processors to determine a motion plan for a mobile electronic device, and display, using a display, an environment representation, wherein the environment representation is a graphical representation of an environment around the mobile electronic device. The instructions further cause the one or more processors to display, to the user, a motion plan representation overlaid on the environment representation, the motion plan representation indicating an area of the environment in which the mobile electronic device may travel within a time horizon, the motion plan representation extending from a first end corresponding to a current location of the mobile electronic device to a second end corresponding to an expected future location of the mobile electronic device at an end of the time horizon, wherein the motion plan representation is updated continuously to reflect changes to the current location of the mobile electronic device and changes to the motion plan. The instructions further cause the one or more processors to control the mobile electronic device using the motion plan.

### BRIEF DESCRIPTION OF THE DRAWINGS

FIG. 1 is an illustration of a device.

FIG. 2 is a block diagram showing operation of a control system and an intent analyzer.

FIG. 3 is an illustration showing outputs of the intent analyzer.

FIGS. 4-6 are block diagrams of exemplary processes for intent indication.

FIG. 7 is a block diagram of an exemplary computing device.

### DETAILED DESCRIPTION

Embodiments of automated systems described herein may analyze inputs to a control system in order to identify the reasons why an action is being taken, or to identify the reasons why a first action is preferred over a second action to allow the system to present information regarding intended future actions to a user. In some implementations, the inputs are analyzed by a sensitivity analysis that, throughout multiple iterations of analysis, perturbs the inputs to identify a sensitive input that is primarily responsible for the selection of the action of for the preference of a first action over a second action. By presenting information that identifies the action that the automated system will take and by presenting information that identifies the reason the action is being taken, persons near the automated system will gain a higher degree of confidence regarding the actions of the automated system.

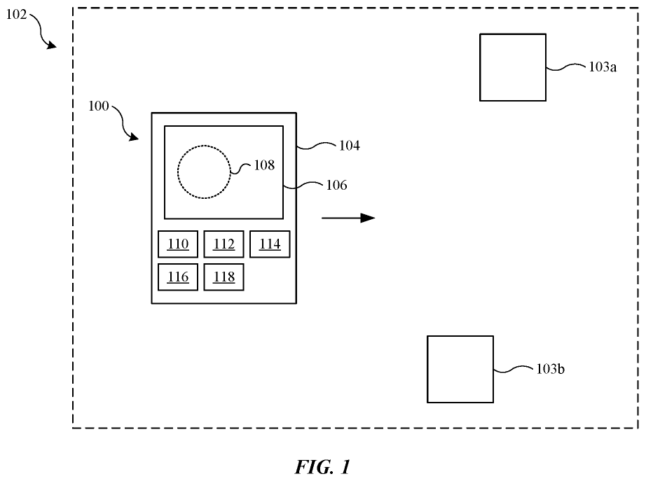

FIG. 1 is an illustration that shows a device 100 that is operating in an environment 102. In the illustrated implementation, the device 100 includes a body 104 that defines an interior space 106 within body 104. A passenger 108 is located in the passenger cabin 106 of the device 100. The passenger 108 may be referred to as a user. An arrow represents movement of the device 100 in the environment 102, for example, as the device 100 transports the passenger 108 from an origin (e.g., a first location) to a destination (e.g., a second location). The device 100 is located in the environment 102. The device 100 is a mobile electronic device. The device 100 in some embodiments is a road-going vehicle supported by wheels and tires and is configured to carry passengers and/or cargo. Other objects may also be located in the environment including static objects 103a (e.g., fixed obstacles, barriers, pavement defects, and so forth) and dynamic objects 103b (e.g., persons and vehicles).

The device 100 may include a control system 112, a sensor system 110, an actuator system 114, a human interface device, such as an interface 116, and an intent analyzer 118. These components may be attached to and/or form parts of the body 104 or other physical structure of the device 100, and may be electrically interconnected to allow transmission of signals, data, commands, etc., between them, either over wired connections, (e.g., using a wired communications bus) or over wireless data communications channels. Other components may be included in the device 100, such as conventional vehicle components including chassis components, aesthetic components, suspension components, power system components, and so forth.

The sensor system 110 is configured to obtain information representing states of the environment 102 and the device 100 for use by the control system 112. The sensor system 110 includes one or more sensor components that are configured to output information representing a characteristic (e.g., a measurement, an observation, etc.) of the device 100, the environment 102, the static objects 103a, and/or the dynamic objects 103b. Sensors that may be included as part of the sensor system 110 include, but are not limited to, imaging devices (e.g., visible spectrum still cameras, infrared spectrum still cameras, visible spectrum video cameras, infrared spectrum video cameras, and so forth), three dimensional sensors (e.g., Lidar, Radar sensors, depth cameras, structured light sensors, and so forth), satellite positioning sensors, and inertial measurement units (e.g., outputting six degree of freedom velocity and acceleration information). The information output by the sensors of the sensor system 110 may be in the form of sensor signals that can be interpreted to understand features of the environment 102, the static objects 103a, and the dynamic objects 103b. The sensor signals that are obtained by the sensor system 110 may include two-dimensional images and/or three-dimensional scans (e.g., point clouds, depth images, and so forth) of the environment. This information may be referred to as environment information. Thus, the sensor system 110 may be configured to provide information to the control system 112, such as observations of the environment 102 as perceived by the sensor system 110, and current states of the device 100 as perceived by the sensor system 110.

The control system 112 is configured to determine control decisions for the device 100 based on the information from the sensor system 110 and/or other information. The control system 112 is configured to control movement of the device 100 in an automated control mode, and may implement other control modes such as manual control and teleoperation control. In the automated control mode, the control system 112 is configured to make decisions regarding motion of the device 100 using information from the sensor system 110 and/or other information. To determine how to move the device 100, the control system 112 implements perception, motion planning, and control functions. These functions may be incorporated in hardware, firmware, and/or software systems.

Perception functions of the control system 112 include interpreting the sensor outputs from the sensor system 110 to understand the environment 102 and objects in the environment 102, such as by generating a computer-interpretable representation of the environment 102 that is usable by the control system 112 during motion planning. Motion planning functions of the control system 112 include determining how to move the device 100 in order to achieve an objective, such as by moving along a route from a current location toward a destination location, as determined using route planning functions. Motion control functions of the control system 112 include determining actuator commands and transmitting the actuator commands to the actuator system 114 to cause the device 100 to move in accordance with the decisions made by the motion planning functions, such as by controlling the actuator system 114 in a manner that causes the device 100 to follow a trajectory determined by the motion planning functions to travel towards the destination location.

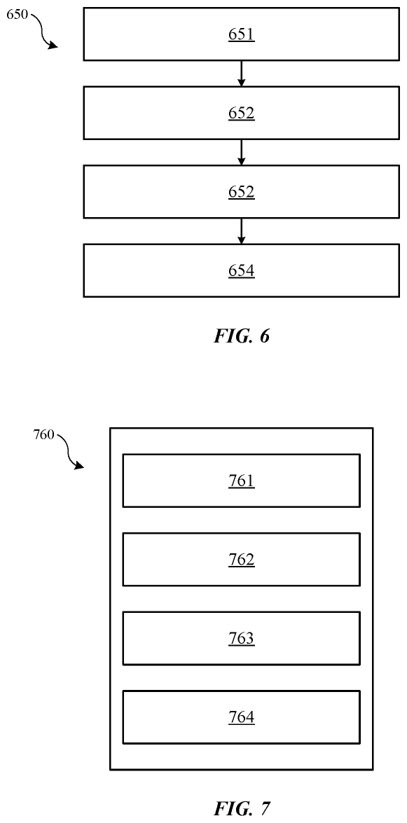

Various control algorithms, now known or later developed, may be utilized as a basis for automated control of the device 100 by the control system 112. The control system 112 can be implemented in the form of one or more computing devices that are provided with control software that includes computer program instructions that allow control system 112 to perform the above-described functions. In some implementations, the control system 112 employs a computing device 760 described with reference to FIG. 7, below. Operation of the control system 112 will be described further herein.

The actuator system 114 is configured to cause motion of the device 100 and may be controlled by the control system 112 in the automated control mode, for example, by transmission of the actuator commands from the control system 112 to the actuator system 114, so that the actuator system 114 may operate in accordance with the actuator commands. The actuator system 114 includes one or more actuator components that are able to affect motion of the device 100. The actuator components can accelerate, decelerate, steer, or otherwise influence motion of the device 100. These components can include suspension actuators, steering actuators, braking actuators, and propulsion actuators such as one or more electric motors.

The interface 116 is configured to present information to the user 108 (e.g., by a display of information caused by the control system 112) and to receive inputs from the user 108 (e.g., by transmission of signals representing the inputs to the control system 112. The information presented to the user 108 by the interface 116 may be information regarding the control decisions and/or other aspects of operation of the control system 112. The inputs received by the control system 112 may be user input that are received from the user 108 for use by the control system 112. To present information and receive user inputs, the interface 116 includes components, such as input device and output devices, that allow the user to interact with various system of the device 100. As examples, the interface 116 may include display screens, touch-sensitive interfaces, gesture interfaces, audio output devices, voice command interfaces, buttons, knobs, control sticks, control wheels, pedals, and so forth.

The intent analyzer 118 is configured to analyze operation of the control system 112 and to present information regarding operation of the device 100 by the control system to the user 108 using the interface 116. Operation of the intent analyzer 118 will be described further herein.

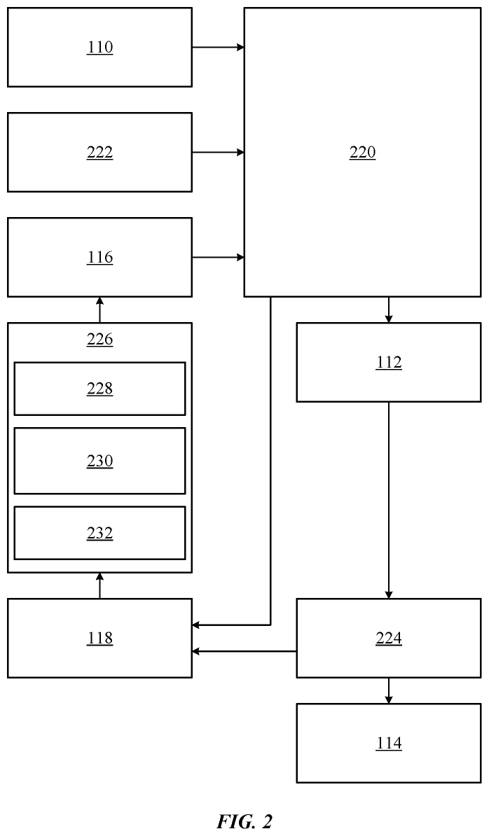

FIG. 2 is a block diagram showing operation of systems of the device 100, including the control system 112 and the intent analyzer 118. In the automated control mode, the control system 112 makes control decisions using inputs 220. The inputs 220 include information obtained from the sensor system 110, previously stored information obtained from storage 222 (e.g., a storage device) that is associated with the control system 112, and information representing user inputs that are obtained from the interface 116 as a result of interaction of the user 108 with the interface 116. The inputs 220 are used by the control system 112 to determine a motion plan 224 for the device 100. The motion plan 224 describes how the device 100 will move between a first location and a second location, such as between a current location and a location at which the device 100 is intended to be in the future (e.g., 10-20 seconds after the current time). The motion plan 224 may include a trajectory that describes the path that the device 100 will take through the environment 102, and a velocity profile that describes that speed at which the device 100 will move, such as by explicitly or implicitly describing acceleration and deceleration of the device 100 as it moves along the trajectory. Determination of the motion plan 224 will be described further herein.

The inputs 220 that are obtained from the sensor system 110 may describe the environment 102, including locations of the static objects 103a and locations and tracked motions of the dynamic objects 103b. The inputs that are obtained from the interface 116 may include inputs from the user 108, such as a selection of a destination for the device 100. The inputs 220 that are obtained from the storage 222 may include previously stored user preference information, for example, describing comfort related preferences of the user 108. The inputs 220 that are obtained from the storage 222 may also include regulatory information inputs that describe traffic rules. The inputs 220 that are obtained from the storage 222 may also include navigation information inputs such as mapping information, historical traffic conditions, and current traffic conditions. The inputs 220 may also include dynamic limits for the device 100, such as a maximum speed and maximum accelerations (e.g., in up to six degrees of freedom) at which the device 100 may be operated by the control system 112, and this information may be obtained from the storage 222 or otherwise made available to the control system 112. The inputs 220 may also include factors, such as cost factors, that are used by the control system 112 to determine the motion plan 224, to calculate a score that represents compliance of the motion plan 224 with various criteria by which the suitability of the motion plan 224 may be judged, and to compare two or more possible motion plans to determine which is preferred and will be used as the motion plan 224.

The control system 112 uses the inputs 220 as a basis for determining the motion plan 224 for the device. Determining the motion plan 224 may include determining locations of the static objects 103a and the dynamic objects 103b by interpreting the outputs of the sensor system 110, and generating the motion plan in a manner that is consistent with travel toward a destination location while complying with constraints. Constraints used in generation of the motion plan 224 may include constraints defined by the inputs 220, such as obeying traffic rules, moving the device 100 in a manner that is consistent with comfort related preferences, and moving the device 100 in a manner that does not exceed dynamic limits.

The motion plan 224 may be determined by the control system 112 in a manner that generates a score that indicates how well the motion plan complies with the constraints and/or other performance. As an example, the score may be generated using a function that awards a higher score for minimizing costs (e.g., travel time or fuel consumption), awards a higher score for increasing comfort, awards a lower score for violating constraints, and so forth. As an example, the score may be determined as a function of multiple component scores that each represent compliance with desired condition or compliance with a constraint (e.g., non-violation of the constraint). Desired conditions and constraints may be represented as factors, such as cost factors, in some implementations. Thus, a higher score may correspond to a motion plan that is considered to be preferable to a lower scored motion plan, allowing motion plans to be ranked. The motion plan 224 may be one of multiple alternative motion plans that are determined at a particular time point, and each of the multiple motion plans may be associated with a score, allowing the multiple motion plans to be ranked, and allowing a highest scored motion plan from the multiple motion plans to be designated as a preferred motion plan.

The intent analyzer 118 is configured to analyze the motion plan 224 and the inputs 220, and to generate an output 226 that can be displayed to the user 108 by the interface 116 (e.g., on a display screen that is associated with the device 100 and is accessible to the user 108) in order to allow the user 108 to understand the motion plan 224 and the reasons for the motion plan 224. The output 226 may include an environment representation 228, a motion plan representation 230, and an intent indication 232.

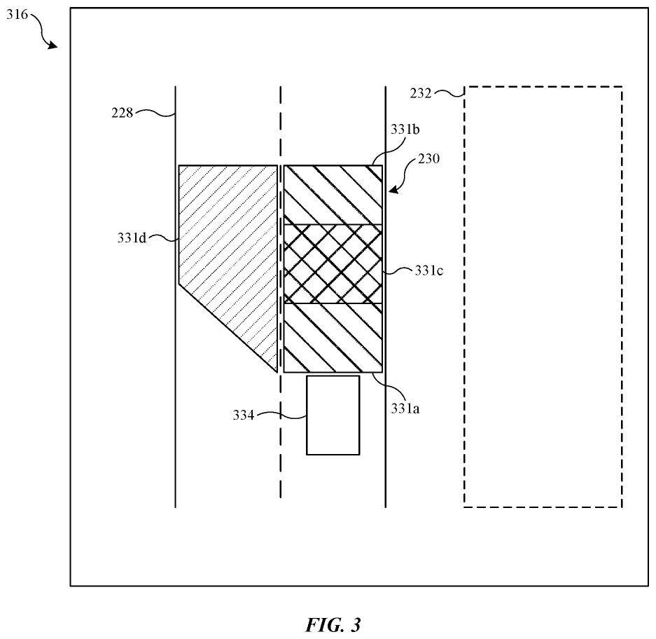

FIG. 3 is a schematic illustration in which the output 226 is presented on a display 316 of the interface 116 in graphical form. In the illustrated implementation the environment representation 228, the motion plan representation 230, and the intent indication 232 are graphical elements that are combined and are output for display. A vehicle indicator 334 is also presented on the display 316 (e.g., overlaid on the environment representation 228) at a position relative to the environment representation 228 that represents the current location of the device 100 in order to show the user 108 where the device 100 is relative to the environment 102.

The output 226 may include an environment representation 228, which is a graphical representation of the environment 102. The environment representation 228 is in a graphical form, so that it may be combined with other graphical elements and presented to the user 108, such as on a display screen that is included in the interface 116 of the device 100. The purpose of the environment representation 228 is to provide context for presentation of information about the motion plan 224 and the reasons for the control decisions made by the control system 112, and therefore, the environment representation 228 may be in any suitable form that is consistent with this purpose. The environment representation 228 may be generated using stored information (e.g., mapping information), images from image sensors of the sensor system 110, three-dimensional scans from three-dimensional sensors of the sensor system 110, information from other sources, or combinations thereof. As one example, the environment representation 228 may be a map that, for example, includes lines representing roads and/or travel lanes in the area in which the device 100 is traveling. As another example, the environment representation 228 may be a three-dimensional representation of the environment 102 around the device 100. As another example, the environment representation 228 may be an image (e.g., an image from a single camera or a composite image generated from multiple images obtained from multiple cameras) that shows the environment 102 around the device 100.

The motion plan representation 230 is information that describes the motion plan 224, and may be updated continuously during operation of the device 100 (e.g., at fixed time intervals) to reflect changes to the current location of the device 100 and changes to the motion plan 224. In the illustrated implementation, the motion plan representation is a graphical representation of the motion plan 224. The motion plan representation 230 may be a graphical indicator of the motion plan 224 that is overlaid on the environment representation 228 in order to show the location and extent of the motion plan representation 230 relative to the environment representation 228. To allow the user to understand how the device 100 may move in the future, the motion plan representation 230 may have a shape and extents that correspond to expected motion of the device 100 according to the motion plan 224. As an example, the shape and extents of the motion plan representation 230 may indicate an area of the environment in which the device 100 may travel within a time horizon, and the motion plan representation may extend from a first end 331a corresponding to a current location of the device 100 to a second end 331b corresponding to an expected future location of the device 100 at an end of the time horizon.

The time horizon may be a fixed time interval that extends from a current time to a future time corresponding to the end of the fixed time interval. Thus the end of the time horizon may be determined by adding the fixed duration time interval to a current time. As an example, if the time horizon is eight seconds, the motion plan representation 230 will always show where the device 100 will be within the next eight seconds, the second end 331b of the motion plan representation 230 corresponding to the location of the device 100 eight seconds in the future. As time progresses, the time horizon remains fixed, and the motion plan representation 230 would continue to represent the subsequent eight seconds (or other fixed time interval) of operation of the device 100.

By updating the motion plan representation 230 as the device 100 moves, the motion plan representation will always be updated to show where the device 100 will be at a point in the future corresponding to the end of the time horizon. A length of the motion plan representation 230 between the first end 331a of the motion plan representation and the second end 331b of the motion plan representation 230 represents an expected travel distance of the device 100 during the time horizon. Because the time horizon is a fixed duration interval, the length of the motion plan representation 230 also varies according to an average speed of the device 100 during the time horizon. As an example, as the device 100 comes to a stop and will remain stopped for a time period longer than the time horizon, the length of the motion plan representation 230 may reduce until it reaches zero length or reaches a minimum length set to indicate no movement during the time horizon. The length of the motion plan representation 230 will start increases prior to resumed movement by the device 100.

The motion plan representation 230 may include a graphical style that is used to indicate information about motion of the device 100 during the time period. The appearance of all of or part of the motion plan representation 230 may be changed, such as by changing the color or by applying a dynamic graphical effect, in order to indicate an upcoming aspect of the motion of the device 100. As examples, changes in acceleration (e.g., longitudinal acceleration or lateral acceleration) within the time horizon may be indicated by changing the color of the motion plan representation 230, or by otherwise changing the appearance of the motion plan representation 230. In some implementations, the color of a portion 331c of the graphical indicator may be changed to represents an acceleration of the device 100 during the time horizon, where the extent of the portion 331c corresponds to the spatial or temporal extent over which the acceleration is expected. Thus, short periods of time in which the acceleration of the device 100 changes by more than a threshold value may be indicated by the color of the portion 331c, and the color of the portion 331c may further be varied according to the magnitude of the acceleration.

The output 226 may include a second motion plan representation 331d that corresponds to a second motion plan that is determined by the control system 112 as an alternative to the motion plan 224 (which may be referred to as a first motion plan). As an example, the first motion plan may correspond to a first intended travel path around an obstacle, and the second motion plan may correspond to a second intended travel path that is different from the first travel path. In the illustrated implementation, the second motion plan representation 331d shows travel in a different travel lane of a roadway as compared to the motion plan representation 230 (e.g., the first motion plan representation). The second motion plan representation 331d may be equivalent to the motion plan representation 230 but presented with a different color, opacity or other graphical style to differentiate it. In some implementations, the interface 116 may be configured to receive an input from the user 108 requesting use of the second motion plan corresponding to the second motion plan representation 331d.

The intent indication 232 includes information indicates to the user 108 why an action is being taken by the device 100. The intent indication 232 may be in the form of explanatory text, in the form of an icon, or in another form that represents the reason for the action. To generate the intent indication 232, the intent analyzer 118 is configured to identify reasons why certain actions are taken as part the motion plan 224 and/or to identify why the motion plan 224 is preferred over an alternative motion plan (e.g., why a first motion plan is preferred over a second motion plan). In one implementation, the intent analyzer 118 may search for nearby objects, such as the static objects 103a and the dynamic objects 103b, that may have influenced the motion plan 224, determine how the presence of those objects may have influenced the motion plan 224, and incorporate information describing how the presence of those objects may have influenced the motion plan 224 in the intent indication 232. This may be performed, for example, using a rules based approach that considers the current location and states of the device 100 relative to the current locations and states of the static objects 103a and the dynamic objects 103b to determine a possible explanation for the motion plan 224. In another implementation, the intent analyzer 118 may search for conditions in the vicinity of the device 100, such as current traffic conditions, detours, or construction activities that may have influenced the motion plan 224, determine those circumstances may have influenced the motion plan 224, and incorporate information describing how those circumstances may have influenced the motion plan 224 in the intent indication 232. This may be performed, for example, using a rules based approach that considers the current location and states of the device 100 relative to circumstances affecting the transportation network (e.g., streets) in the vicinity of the device 100.

In some implementations, the intent analyzer 118 is configured to perform a sensitivity analysis in order to identify reasons why certain actions are taken as part of the motion plan 224 and/or to identify why the motion plan 224 is preferred over an alternative motion plan (e.g., why a first motion plan is preferred over a second motion plan). The sensitivity analysis that is performed by the intent analyzer 118 is intended to determine which of the inputs 220 are sensitive inputs that have a significant effect on the motion plan 224. A sensitive input is one, that if changed, would result in a significantly different outcome for the motion plan 224, such as changing the route the device 100 is travelling on, stopping as opposed to not stopping, accelerating as opposed to decelerating, changing lanes as opposed to staying in a current lane, turning as opposed to taking no action, and so forth. As one example, an input may be identified as a sensitive input if it changing the value of the input would result in a difference to the motion plan 224 that is in excess of a predetermined magnitude (e.g., in acceleration rates or positions), or is of a type that has be identified as corresponding to a sensitive (e.g., predetermined of categories of differences that are considered indicative of a sensitive input).

Numerous known methods may be used by the intent analyzer to perform the sensitivity analysis. Some methods include changing one or more of the inputs 220 to understand how the inputs 220 affect the motion plan 224 (e.g., how would the motion plan 224 change if the inputs were different). Non-sensitive inputs, if changed, would result in no change to the motion plan or would result in slight but insignificant differences in the motion plan (e.g., differences in tracking within a lane, differences in acceleration or deceleration rates below a comfort or perceptibility threshold, and so forth).

In one implementation, the intent analyzer 118 may perform the sensitivity analysis by performing multiple iterations of the motion planning process used to determine the motion plan 224. For each iteration of the motion planning process performed as part of the sensitivity analysis, the resulting motion plan is determined up changing one of the inputs 220 to determine whether that input is a sensitive input. As one example, an input can be identified as sensitive if changing the input changes the motion plan 224. A magnitude of the change can be quantified, such as by using a formula that assigns a numerical value to the differences between the motion plan 224 and the motion plan resulting from the sensitivity analysis. As one example, one of the inputs 220 may be identified as sensitive if the numerical value representing the magnitude of the change is above a threshold value. As another example, one of the inputs 220 may be identified as sensitive if the numerical value representing the magnitude of the change is greater than the values representing the magnitude of the change resulting from analysis of other ones of the inputs.

The intent analyzer 118 may use a sensitivity analysis to compare the motion plan 224 with an alternative motion plan, which may be referred to as a first motion plan and a second motion plan. The control system 112 determines the first motion plan and the second motion plan, and also determines a first score for the first motion plan a second score for the second motion plan. The first score and the second score represent suitability of the first motion plan and the second motion plan. The first score for the first motion plan is higher than the second score for the second motion plan, indicating that the first motion plan is preferred over the second motion plan. After determining the scores for the first motion plan and the second motion plan, the intent analyzer 118 performs a sensitivity analysis to identify a sensitive input that explains why the first motion plan is preferred over the second motion plan. Across multiple iterations of the sensitivity analysis, the inputs 220 that are used to determine the first motion plan are changed slightly, and scores are determined for each of the changed motion plans. In this example, the sensitive input causes the first score for the first motion plan to be higher than the second score for the second motion plan. Modification of the sensitive input may cause the score for the modified version of the first motion plan to be lower than the score for the second motion plan, thereby identifying the sensitive input. Thus, by identifying the sensitive input, the sensitivity analysis identifies one of the inputs 220 as a reason why the first motion plan is preferred over the second motion plan.

Based on identification of the sensitive input, the intent analyzer 118 may generated the intent indication 232 so that it explains why the first motion plan is preferred over the second motion plan, such as by generating text that identifies the sensitive input or a circumstance associated with the sensitive input as a reason why the first motion plan is preferred over the second motion plan. As one example, the sensitive input may relate to occupant comfort, and the intent indication 232 may include text or an icon indicating that the motion plan 224 was selected to increase occupant comfort. As another example, the sensitive input may relate to road defect (e.g., a pothole or other feature) avoidance, and the intent indication 232 may include text or an icon indicating that the motion plan 224 was selected to travel around a road defect. As another example, the sensitive input may relate to object avoidance, and the intent indication 232 may include text or an icon indicating that the motion plan 224 was selected to travel around an object. As another example, the sensitive input may relate to travel time, and the intent indication 232 may include text or an icon indicating that the motion plan 224 was selected to reduce travel time.

In some situations, the motion plan 224 includes a motion maneuver intended to avoid a feature of the environment 102, referred to herein as an environment feature, such as an object or a road defect, and the inputs 220 are analyzed by the intent analyzer 118 to identify the environment feature that caused the motion maneuver to be included in the motion plan 224. Analysis of the inputs 220 may be a sensitivity analysis as previously described. Information that describes the motion maneuver and identifies the environment feature may then be included in the intent indication 232, for example, in the form of explanatory text or an icon.

The device 100 is configured to implement processes for intent indication, as will be explained herein with reference to example embodiments. The processes described herein may be performed using systems that are implemented using one or more computing devices, such as the control system 112 and the intent analyzer 118 of the device 100, which may be implemented using the computing device 760 of FIG. 7. As an example, the processes described herein, and the operations thereof may be implemented in the form of a method that is implemented using the device 100 and its various systems. As an example, the processes described herein, and the operations thereof may be implemented in the form an apparatus that includes a memory and one or more processors that are configured to execute computer program instructions. The computer program instructions are executable by one or more computing devices to cause the one or more computing devices to perform functions that correspond to the steps of the processes. As an example, the processes described herein, and the operations thereof may be implemented in the form of a non-transitory computer-readable storage device including program instructions executable by one or more processors that, when executed, cause the one or more processors to perform operations that correspond to the steps of the processes.

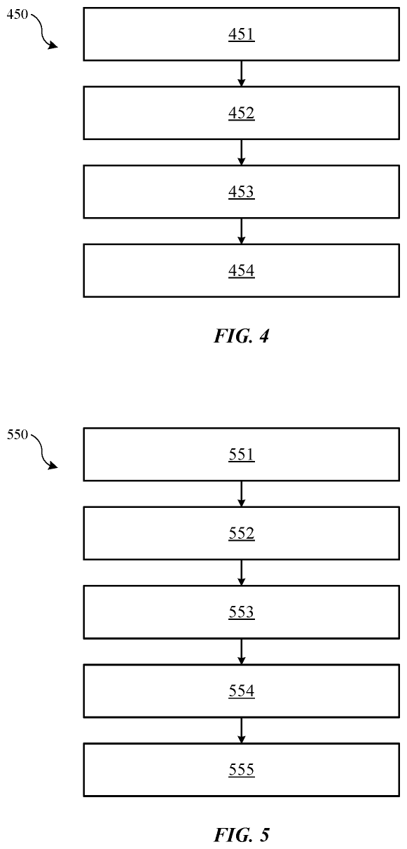

FIG. 4 is a block diagram of a process 450 for intent indication. The process 450 may be performed by the device 100, including by operation of the control system 112 and the intent analyzer 118 as previously described. The process 450 may be performed while the device 100 is travelling from a current location to a destination location, and may include transport, by the device 100, of the user 108. The features described with reference to FIGS. 1-3 may be incorporated in the process 450.

In operation 451, the process 450 include determining the motion plan 224 for the device 100. The motion plan 224 may be determined in a manner consistent with travel from a current location of the device 100 toward a destination location. The motion plan 224 may be determined as described with respect to the control system 112, and may be usable to control the actuator system 114 of the device 100.

In operation 452, the process 450 includes and displaying, to the user 108, a graphical representation of the environment 102, such as the environment representation 228. The environment representation 228 may be output to the display 316 or to another display device that is associated with the interface 116 of the device 100. As examples, the environment representation may be or include a map that represents the environment 102, a three-dimensional rendering of the environment 102 based on information from the sensor system 110, or images of the environment 102 that are obtained from the sensor system 110.

In operation 453, the process 450 includes displaying, to the user, a graphical indicator of the motion plan, such as the motion plan representation 230, overlaid on the graphical representation of the environment, such as the environment representation 228. In operation 453, the motion plan representation 230 indicates an area of the environment 102 in which the device 100 may travel within the time horizon, and may extend from the first end 331a, corresponding to a current location of the device 100, to the second end 331b, corresponding to an expected future location of the device 100 at an end of the time horizon. The motion plan representation 230 is updated continuously to reflect changes to the current location of the device 100 and changes to the motion plan 224.

In operation 453, the end of the time horizon may be determined by adding a fixed duration time interval to a current time. A length of the motion plan representation 230 between the first end 331a and the second end 331b represents an expected travel distance of the device 100 during the time horizon, and the length of the motion plan representation 230 may be updated continuously to reflect changes to the current location of the device 100 and to reflect changes to the motion plan 224. In operation 453, the motion plan representation 230 may be output such that a color of at least a portion of the motion plan representation 230, such as the portion 331c, represents an acceleration of the device 100 during the time horizon.

Some implementations of the process 450 include determining a second motion plan in operation 451 and, in operation 453, displaying, to the user 108, a second graphical indicator of the second motion plan, such as the second motion plan representation 331d, overlaid on the environment representation 228. The motion plan representation 230 and the second motion plan representation 331d may be displayed with at least one of differing colors or differing opacities.

In operation 454, the process 450 includes controlling the device 100 using the motion plan. Operation 454 may include transmitting actuator commands and/or other information from the control system 112 to the actuator system 114 in order to cause the actuator system 114 to operate the actuators of the device 100 in a manner that causes motion of the device 100 that is consistent with the motion plan.

FIG. 5 is a block diagram of a process 550 for intent indication. The process 550 may be performed by the device 100, including by operation of the control system 112 and the intent analyzer 118 as previously described. The process 550 may be performed while the device 100 is travelling from a current location to a destination location, and may include transport, by the device 100, of the user 108. The features described with reference to FIGS. 1-3 may be incorporated in the process 550.

Operation 551 includes determining a first motion plan and a second motion plan for the device 100, based on the inputs 220. The first motion plan and the second motion plan are equivalent to the motion plan 224 and may be determined in the manner described with respect to the motion plan 224. Operation 552 includes determining a preference for the first motion plan relative to the second motion plan. As an example, determining the preference for the first motion plan relative to the second motion plan may include determining a first score for the first motion plan and a second score for the second motion plan. The first score represents suitability of the first motion plan and the second score represents suitability of the second motion plan. In this example, the preference for the first plan over the second plan is determined when the first score is higher than the second score, representing a preference for the first motion plan over the second motion plan.

Operation 553 includes identifying one of the inputs that was used to determine the first motion plan and the second motion plan in operation 551 as a sensitive input that causes the preference for the first motion plan over the second motion plan to be determined in operation 552. To identify the sensitive input, operation 553 may include performing a sensitivity analysis to identify one of the inputs 220 as a sensitive input that causes the first score for the first motion plan to be higher than the second score for the second motion plan. Operation 553 may be implemented in the manner described with respect to the intent analyzer 118. The sensitivity analysis may include modifying at least some of the inputs 220 and recalculating the first score for the first motion plan based on the modified inputs. Modification of the sensitive input may cause the first score for the first motion plan to decrease so that it is lower than the second score for the second motion plan, which thereby identifies one of the inputs as the sensitive input. As examples, the sensitive input may relate to occupant comfort, road defect avoidance, obstacle avoidance, travel time, or other circumstances.

Operation 554 includes presenting to the user 108, using a display, such as the display 316, information that describes the first motion plan, wherein the information includes an explanation indicating the sensitive input as a reason why the first motion plan is preferred over the second motion plan. Operation 554 may include presenting information that describes the first motion plan, such as the motion plan representation 230, and includes an indication, such as the intent indication 232. The intent indication 232 is based on the sensitive input and explains why the first motion plan is preferred over the second motion plan. The indication that explains why the first motion plan is preferred over the second motion plan includes text that is determined based on the sensitive input, or may include an icon that represents the sensitive input.

In operation 554, presenting the information that describes the first motion plan may include display of a first graphical indicator of the first motion plan, such as the motion plan representation 230 and a second graphical indicator of the second motion plan, such as the second motion plan representation 331d. The motion plan representation 230 and the second motion plan representation 331d may be displayed with differing visual characteristics such as at least one of differing colors or differing opacities.

In operation 555, the process 550 includes controlling the device 100 using one of the first motion plan or the second motion plan. Operation 555 may include transmitting actuator commands and/or other information from the control system 112 to the actuator system 114 in order to cause the actuator system 114 to operate the actuators of the device 100 in a manner that causes motion of the device 100 that is consistent with the motion plan.

FIG. 6 is a block diagram of a process 650 for intent indication. The process 650 may be performed by the device 100, including by operation of the control system 112 and the intent analyzer 118 as previously described. The process 650 may be performed while the device 100 is travelling from a current location to a destination location, and may include transport, by the device 100, of the user 108. The features described with reference to FIGS. 1-3 may be incorporated in the process 650.

Operation 651 includes determining the motion plan 224 for the device 100, based on the inputs 220, where the motion plan 224 includes a motion maneuver. As examples, the motion maneuver may include planned motion, by the device 100, that is intended to avoid contact with a road defect, an obstacle, or other object. The motion plan 224 may be determined as previously described with respect to the control system 112.

Operation 652 includes analyzing the inputs 220 to identify an environment feature (e.g., a feature located in the environment 102 around the device 100) that caused the motion maneuver to be included in the motion plan 224. As examples, the environment feature may be one of the static objects 103a or one of the dynamic objects 103b. Analyzing the inputs 220 to identify the environment feature that caused the motion maneuver to be included in the motion plan 224 may include identifying the environment feature by performing a sensitivity analysis in the manner previously described with reference to the intent analyzer 118.

Operation 653 includes presenting, to the user 108, information that describes the motion maneuver and identifies the environment feature, such as the motion plan representation 230 and the intent indication 232. The information that describes the motion maneuver and identifies the environment feature may include text that identifies the environment feature, which may be included as part of the intent indication 232. The information that describes the motion maneuver and identifies the environment feature may include an icon that represents the environment feature. The information that describes the motion maneuver and identifies the environment feature may include a graphical indicator, such as the motion plan representation 230, that represents an intended path of the motion maneuver.

In operation 654, the process 650 includes controlling the device 100 the motion plan 224. Operation 654 may include transmitting actuator commands and/or other information from the control system 112 to the actuator system 114 in order to cause the actuator system 114 to operate the actuators of the device 100 in a manner that causes motion of the device 100 that is consistent with the motion plan.

FIG. 7 is a block diagram of the computing device 760, according to an example. The computing device 760 can be used as a basis for implementing computer-based systems that are described herein, such as the control system 112 and the intent analyzer 118. In the illustrated example, the computing device 760 includes a processor 761, memory 762, storage 763, and communication devices 764. The computing device 760 may include other components, such as, for example, input devices and output devices.

The processor 761 may be in the form of one or more conventional devices and/or one or more special-purpose devices that are configured to execute computer program instructions. Examples of the processor 761 include one or more central processing units, one or more graphics processing units, one or more application specific integrated circuits, and/or one or more field programmable gate arrays. The memory 762 may be a conventional short-term storage device that stores information for use by the processor 761, such as random-access memory modules. The storage 763 is a non-volatile long-term storage device that may be used to store computer program instructions and/or other data, such as a flash memory module, a hard drive, or a solid-state drive. The communication devices 764 allow communications with other systems using any manner of wired or wireless interface that is suitable for transmitting and receiving signals that encode data.

The computing device 760 is operable to store, load, and execute computer program instructions. When executed by the computing device 760, the computer program instructions cause the computing device to perform operations. The computing device 760 may be configured for obtaining information, such as by accessing the information from a storage device, accessing the information from short-term memory, receiving a wired or wireless transmission that includes the information, receiving signals from an input device that represent user inputs, and receiving signals from the sensors that represent observations made by the sensors. The computing device 760 may be configured for making a determination, such as by comparing a value to a threshold value, comparing states to conditions, evaluating one or more input values using a formula, evaluating one or more input values using an algorithm, and/or making a calculation using data of any type. The computing device 760 may be configured for transmitting information, such as by transmitting information between components using a data bus or between systems using a wired or wireless data connection. The computing device 760 may be configured for outputting a signal to control a component, such as a sensor or an actuator. As one example, the signal may cause a sensor to obtain data and provide the data to the computing device 760. As another example, the signal may cause movement of an actuator.

As described above, one aspect of the present technology is the gathering and use of data available from various sources for use in display of robotic intent. Although the present innovation does not require the use of personal information data, it is noted that information such as those stored in user profiles and/or a user's intended destinations can be used to the benefit of users. For example, a user profile may be established that stores user preferences that control the type of information that is presented to users, the amount of information that is presented to users, and the manner in which the information is presented. Accordingly, use of such personal information data enhances the user's experience. Implementers should comply with well-established privacy policies and/or privacy practices that are generally recognized as meeting or exceeding industry or governmental requirements for maintaining personal information data private and secure, to the extent personal information data is used. Collection and/or sharing or personal information data should occur after receiving the informed consent of the users, and the users should be allowed to opt out. Additionally, steps should be taken to safeguard and secure access to such stored information.

What is claimed is:

1. A method, comprising:
determining a first motion plan and a second motion plan for a mobile electronic device based on inputs;
determining a preference for the first motion plan relative to the second motion plan;
identifying one of the inputs as a sensitive input that causes the preference for the first motion plan over the second motion plan;
presenting, using a display, information that describes the first motion plan, wherein the information includes an explanation indicating the sensitive input as a reason why the first motion plan is preferred over the second motion plan; and
controlling the mobile electronic device using one of the first motion plan or the second motion plan.

2. The method of claim 1, wherein the explanation includes text determined based on the sensitive input.

3. The method of claim 1, wherein the explanation includes an icon that represents the sensitive input.

4. The method of claim 1, wherein the sensitive input relates to occupant comfort.

5. The method of claim 1, wherein the sensitive input relates to travel time.

6. The method of claim 1, wherein the first motion plan comprises a first intended travel path around an obstacle, and the second motion plan comprises a second intended travel path different from the first intended travel path.

7. The method of claim 1, wherein presenting the information that describes the first motion plan includes display of a first motion plan representation of the first motion plan and a second motion plan representation of the second motion plan.

8. A non-transitory computer-readable storage device including program instructions executable by one or more processors that, when executed, cause the one or more processors to perform operations, the operations comprising:
determining a first motion plan and a second motion plan for a mobile electronic device based on inputs;
determining a preference for the first motion plan relative to the second motion plan;
identifying one of the inputs as a sensitive input that causes the preference for the first motion plan over the second motion plan;
presenting, using a display, information that describes the first motion plan, wherein the information includes an explanation indicating the sensitive input as a reason why the first motion plan is preferred over the second motion plan; and
controlling the mobile electronic device using one of the first motion plan or the second motion plan.

9. The non-transitory computer-readable storage device of claim 8, wherein the explanation includes text determined based on the sensitive input.

10. The non-transitory computer-readable storage device of claim 8, wherein the explanation includes an icon that represents the sensitive input.

11. The non-transitory computer-readable storage device of claim 8, wherein the sensitive input relates to occupant comfort.

12. The non-transitory computer-readable storage device of claim 8, wherein the sensitive input relates to travel time.

13. The non-transitory computer-readable storage device of claim 8, wherein the first motion plan comprises a first intended travel path around an obstacle, and the second motion plan comprises a second intended travel path different from the first intended travel path.

14. The non-transitory computer-readable storage device of claim 8, wherein presenting the information that describes the first motion plan includes display of a first motion plan representation of the first motion plan and a second motion plan representation of the second motion plan.

15. An apparatus, comprising:
a memory; and
one or more processors that are configured to execute instructions that are stored in the memory, wherein the instructions, when executed, cause the one or more processors to:
determine a first motion plan and a second motion plan for a mobile electronic device based on inputs,
determine a preference for the first motion plan relative to the second motion plan,
identify one of the inputs as a sensitive input that causes the preference for the first motion plan over the second motion plan,
present, using a display, information that describes the first motion plan, wherein the information includes an explanation indicating the sensitive input as a reason why the first motion plan is preferred over the second motion plan, and
control the mobile electronic device using one of the first motion plan or the second motion plan.

16. The apparatus of claim 15, wherein the explanation includes text determined based on the sensitive input.

17. The apparatus of claim 15, wherein the explanation includes an icon that represents the sensitive input.

18. The apparatus of claim 15, wherein the sensitive input relates to occupant comfort.

19. The apparatus of claim 15, wherein the sensitive input relates to travel time.

20. The apparatus of claim 15, wherein the first motion plan comprises a first intended travel path around an obstacle, and the second motion plan comprises a second intended travel path different from the first intended travel path.

21. The apparatus of claim 15, wherein presenting the information that describes the first motion plan includes display of a first motion plan representation of the first motion plan and a second motion plan representation of the second motion plan.
